(19) United States
(12) Patent Application Publication
(10) Pub. No.: US 2011/0235641 A1
(43) Pub. Date: Sep. 29, 2011

(54) COMMUNICATION APPARATUS, METHOD OF CONTROLLING THE COMMUNICATION APPARATUS,AND PROGRAM

(75) Inventor: Katsuhiro Wada, Kawasaki-shi (JP)

(73) Assignee: CANON KABUSHIKI KAISHA, Tokyo (JP)

(21) Appl. No.: 13/052,914

(22) Filed: Mar. 21, 2011

(30) Foreign Application Priority Data
Mar. 23, 2010 (JP) PCT/JP2010/054917

(51) Int. Cl. H04L 12/56

(52) U.S. Cl. 370/392

(57) ABSTRACT

In an apparatus that can be connected to an external apparatus to which multiple addresses are allocated over a network, a packet including certain identification information is transmitted to the external apparatus by using a first address as a destination. If a packet that is received includes the certain identification information, a source address of the received packet is extracted. If the extracted source address is a second address different from the first address, the second address is used as the destination in the subsequent transmission of a packet to the external apparatus.

### TECHNICAL FIELD

The present invention relates to a communication apparatus that can be connected to an external apparatus to which multiple addresses are allocated via a network, a method of controlling the communication apparatus, and a program.

### BACKGROUND ART

Hitherto, various communication apparatuses that are connected to networks (local area network (LAN), the Internet, etc.) to communicate with external apparatuses on the networks are known.

A protocol widely used in the communication apparatuses connected to networks is the Internet protocol. In the Internet protocol, a specific address (Internet Protocol (IP) address) is allocated to each apparatus and the IP addresses are used to identify the respective apparatuses.

In a conventional IP standard (IPv4: IP version 4), one IP address is generally allocated to one network interface. In contrast, in IPv6 (IP version 6) being in widespread use in recent years, upon connection of a communication apparatus to a router, an IP address is allocated to the communication apparatus by the router. In addition, in order to enable communication even if no router exists, one IPv6 address (link local address) is allocated to each network interface. Furthermore, when a Dynamic Host Configuration Protocol (DHCP) server exists, it is possible to acquire an IP address issued by the DHCP server.

As described above, in a typical communication apparatus supporting the IPv6, multiple IP addresses including an IPv4 address and multiple IPv6 addresses are allocated to one network interface.

NPL 1 (Request for Comments (RFC) 3484) is known as a method of selecting an IP address from multiple IP addresses allocated to one network interface. In the method indicated in NPL 1, an IP address having a longer prefix is selected from multiple IP addresses meeting a condition.

In the selection of an IP address by using the method in NPL 1, the following problems can occur. For example, it is assumed that, when an apparatus A to which an IP address A is allocated communicates with an apparatus B to which IP addresses B and C are allocated according to User Datagram Protocol (UDP), the IP address B is specified as the destination address of a request that is transmitted from the apparatus A to the apparatus B. In this case, the IP address A used as the source address of the request from the apparatus A to the apparatus B is set as the destination address of a response from the apparatus B to the apparatus A. Either of the IP addresses B and C is selected by the apparatus B according to the method in NPL 1 as the source address of the response from the apparatus B to the apparatus A. Specifically, the apparatus B selects an IP address having a longer prefix for the IP address A from the IP addresses B and C.

However, a problem occurs when the IP address C is selected as the source address as the result of the selection by the apparatus B. This is because the apparatus A continues to wait for only a response whose source address is the IP address B since the apparatus A has transmitted the request to the IP address B and, if a response whose source address is the IP address C is returned, the apparatus A discards the response.

In order to address such a problem, NPL 2 (WS-Eventing) is known. In a method indicated in NPL 2, Message IDs (Request IDs) are added to data corresponding to layers upper than the transport layer and each response is identified by referring to the IDs. In other words, each request is associated with the corresponding response by referring to the IDs added to the data on the upper layers, instead of the source address of the response. Accordingly, it is possible to associate a request to the corresponding response even if an IP address different from the IP address used as the destination address of the request is used as the source address of the response.

### CITATION LIST

### Non Patent Literature

NPL 1 Internet Engineering Task Force RFC3484 “Default Address Selection for Internet Protocol version 6 (IPv6)” <URL: 1269306530609 0.txt>

NPL 2 Web Services Eventing (WS-Eventing) <URL: http://www.w3.org/Submission/WS-Eventing/>

With the above-described method indicated in NPL 2, it is necessary to add IDs to data corresponding to layers upper than the transport layer.

However, the content of the data corresponding to the layers upper than the transport layer is fixed in some applications and, thus, it may be difficult to add the IDs indicated in NPL 2. In other words, in order to identify responses by referring to the IDs, it is necessary to add IDs to all the packets. For this end, it is necessary to greatly change the content of programs of the applications, thus taking a lot of trouble and increasing the cost.

In order to resolve the above problems, the present invention provides a mechanism to enable communication with an external apparatus to which multiple addresses are allocated without a lot of trouble and an increase in cost.

### SUMMARY OF INVENTION

The present invention provides an apparatus that can be connected to an external apparatus to which a plurality of addresses are allocated over a network. The apparatus includes a transmitting unit configured to transmit a first packet including certain identification information to the external apparatus using a first address in the plurality of addresses as a destination; a receiving unit configured to receive a second packet transmitted from the external apparatus; an extracting unit configured to, if the certain identification information is included in the second packet, extract a source address of the second packet; and a control unit configured to, if the extracted source address is a second address, control the subsequent transmission of a third packet to the external apparatus so as to use the second address as the destination.

Further features of the present invention will become apparent from the following description of exemplary embodiments with reference to the attached drawings.

### BRIEF DESCRIPTION OF DRAWINGS

FIG. 1 is a general view of a communication system in an embodiment of the present invention.

FIG. 2 is a block diagram showing the hardware configuration of a client PC 100 in the embodiment of the present invention.

FIG. 3 is a block diagram showing the hardware configuration of a server 110 in the embodiment of the present invention.

FIG. 4 is a diagram showing the software configuration of the client PC 100 and the server 110 in the embodiment of the present invention.

FIG. 5 is a sequence diagram describing a basic mechanism of packet communication between the client PC 100 and the server 110 in the embodiment of the present invention.

FIG. 6 is a sequence diagram describing the packet communication between the client PC 100 and the server 110 in detail in the embodiment of the present invention.

FIG. 7 is a flowchart describing a process performed by a communication controller 405 in the client PC 100 in the embodiment of the present invention.

FIG. 8 is a flowchart describing a process performed by a communication controller 402 in the server 110 in the embodiment of the present invention.

FIG. 9 is a diagram showing an address management table in the embodiment of the present invention.

FIG. 10 is a sequence diagram describing the packet communication between the client PC 100 and the server 110 in detail in an embodiment of the present invention.

FIG. 11 is a flowchart describing a process performed by the communication controller 405 in the client PC 100 in the embodiment of the present invention.

### DESCRIPTION OF EMBODIMENTS

Embodiments of the present invention will herein be described in detail with reference to the attached drawings. The embodiments described below are not intended to limit the invention according to the claims. All the combinations of features described in the embodiments are not necessarily required for the solution of the invention.

### First Embodiment

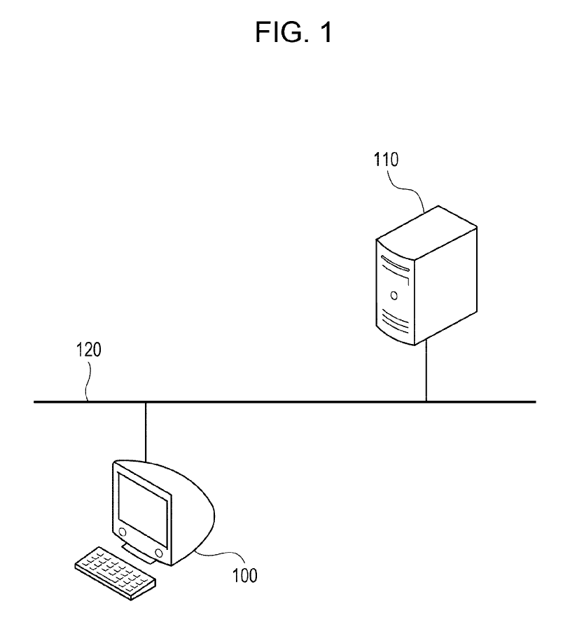

FIG. 1 is a general view of a communication system in an embodiment of the present invention. A client PC 100 is communicatably connected to a server 110 over a network 120. The client PC 100 and the server 110 support IPv6 and multiple IP addresses are allocated to the client PC 100 and the server 110. For example, in transmission of a packet to the server 110, any one of the multiple IP addresses allocated to the server 110 is used as the destination address to transmit the packet to the server 110.

The server 110 provides services to respond to requests from the client PC 100. The services provided by the server 110 include the server functions of a Web service, a Domain Name Server (DNS) service, an e-mail service, a Simple Network Management Protocol (SNMP) agent service, and the WS-Eventing.

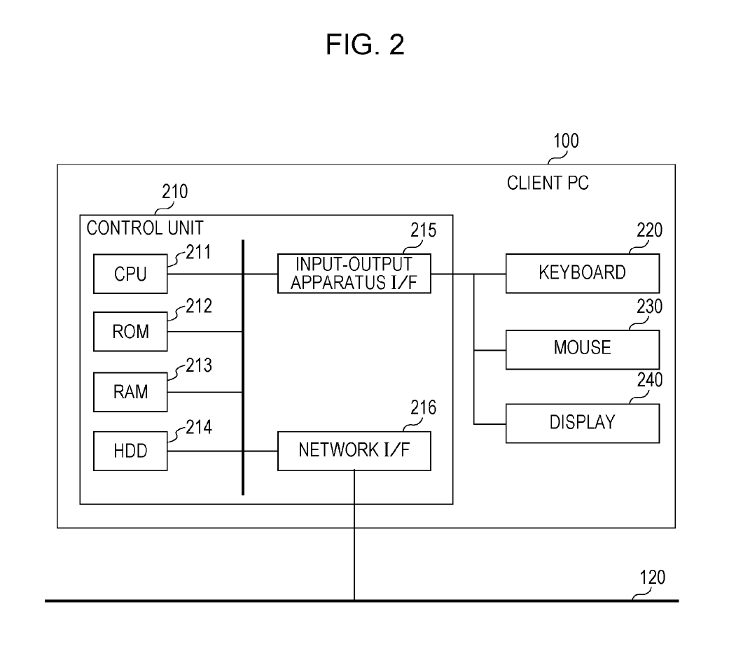

FIG. 2 is a block diagram showing the hardware configuration of the client PC 100. A control unit 210 including a central processing unit (CPU) 211 controls the entire operation of the client PC 100. The CPU 211 reads out control programs stored in a read only memory (ROM) 212 to perform a variety of control processing. A random access memory (RAM) 213 is used as a main memory of the CPU 211 and a temporary storage area, such as a working area. A hard disk drive (HDD) 214 stores image data and various programs. A keyboard 220, a mouse 230, and a display 240 are connected to the control unit 210 through an input-output apparatus interface (I/F) 215.

A network I/F 216 is used to connect the control unit 210 (the client PC 100) to the network 120. The network I/F 216 controls communication with an external apparatus (for example, the server 110) over the network 120.

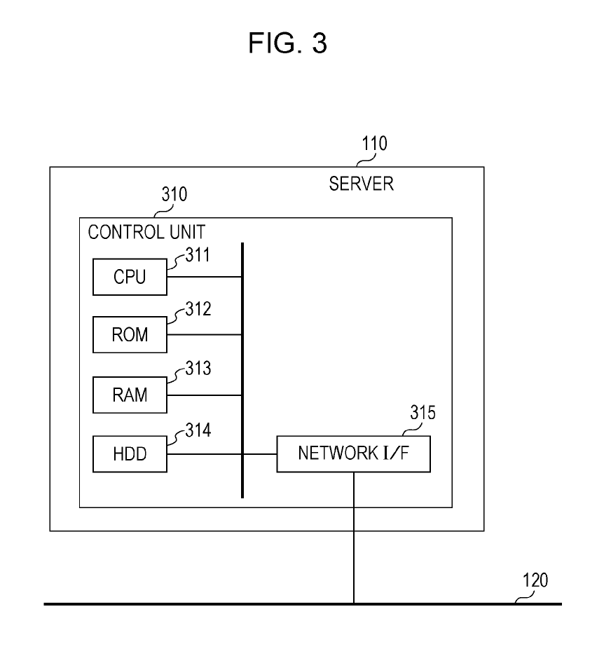

FIG. 3 is a block diagram showing the hardware configuration of the server 110. A control unit 310 including a CPU 311 controls the entire operation of the server 110. The CPU 311 reads out control programs stored in a ROM 312 to perform a variety of control processing. A RAM 313 is used as a main memory of the CPU 311 and a temporary storage area, such as a working area. An HDD 314 stores image data and various programs.

A network I/F 315 is used to connect the control unit 310 (the server 110) to the network 120. A variety of information is transmitted to and received from another apparatus (for example, the client PC 100) on the network 120 through the network I/F 315.

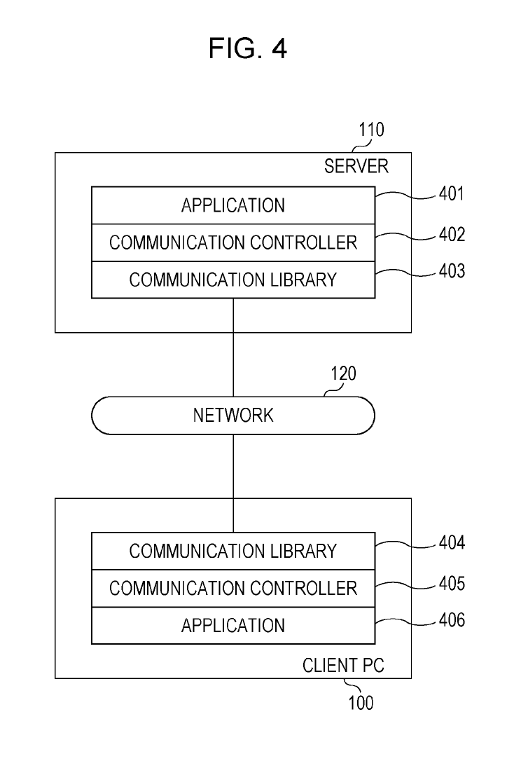

FIG. 4 shows the software configuration of the client PC 100 and the server 110. Each functional module shown in FIG. 4 is realized by the CPU 211 in the client PC 100 and the CPU 311 in the server 110 that execute the control programs.

The client PC 100 includes an application 406. Although only one application is shown here, multiple applications may be provided in the client PC 100.

When the application 406 transmits and receives data to and from the server 110, the application 406 submits a request to a communication controller 405 in the client PC 100. The communication controller 405 communicates with the server 110 via a communication library 404 in the operating system in response to the request from the application 406. The communication library 404 supports communication, for example, by Remote Procedure Call (RPC) and by using Web services, in addition to socket communication.

The server 110 includes an application 401. Although only one application is shown here, multiple applications may be provided in the server 110.

When the application 401 transmits and receives data to and from the client PC 100, the application 401 submits a request to a communication controller 402 in the server 110. The communication controller 402 communicates with the client PC 100 via a communication library 403 in the operating system in response to the request from the application 401. The communication library 403 supports communication, for example, by the RPC and by using Web services, in addition to the socket communication, like the communication library 404.

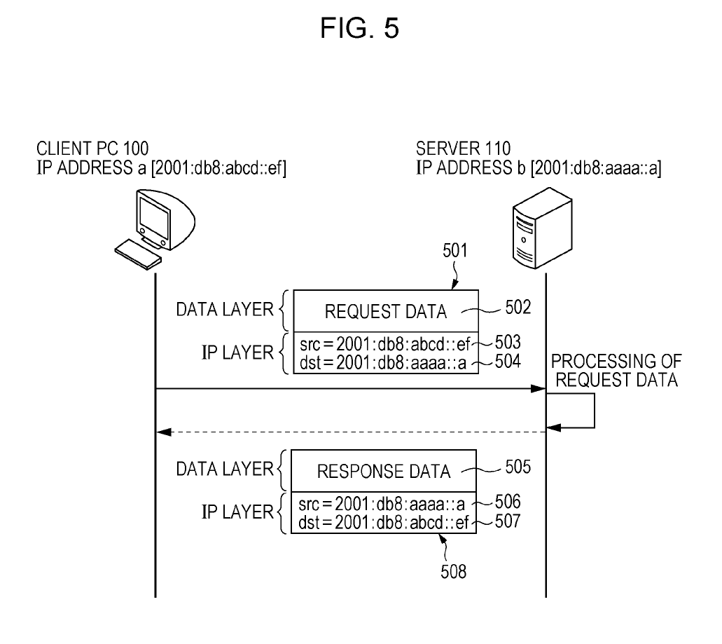

FIG. 5 is a sequence diagram describing a basic mechanism of packet communication between the client PC 100 and the server 110. It is assumed here that only one IP address a (2001:db8:abcd::ef) is allocated to the client PC 100 for simplicity although multiple IP addresses are allocated to the client PC 100, as described below. Similarly, it is assumed here that only one IP address b (2001:db8:aaaa::a) is allocated to the server 110 although multiple IP addresses are allocated to the server 110.

A transmission packet 501 transmitted from the client PC 100 to the server 110 includes a destination address 504, a source address 503, and request data 502. The destination address 504 and the source address 503 correspond to “Destination Address” and “Source Address”, respectively, in the IP addresses on the network layer in an Open Systems Interconnection (OSI) reference model. In the transmission packet 501, the IP address b is used as the destination address and the IP address a is used as the source address. The request data 502 included in the transmission packet 501 corresponds to the transport layer in the OSI reference model.

The server 110, which receives the transmission packet 501, processes the request data 502 to generate response data 505 to the request data 502. The server 110 transmits a reply packet 508 including the response data 505 to the client PC 100.

The reply packet 508 includes a destination address 507, a source address 506, and the response data 505. The destination address 507 and the source address 506 correspond to the “Destination Address” and the “Source Address”, respectively, in the IP addresses on the network layer in the OSI reference model. In the reply packet 508, the IP address a used as the source address 503 of the transmission packet 501 is used as the destination address 507.

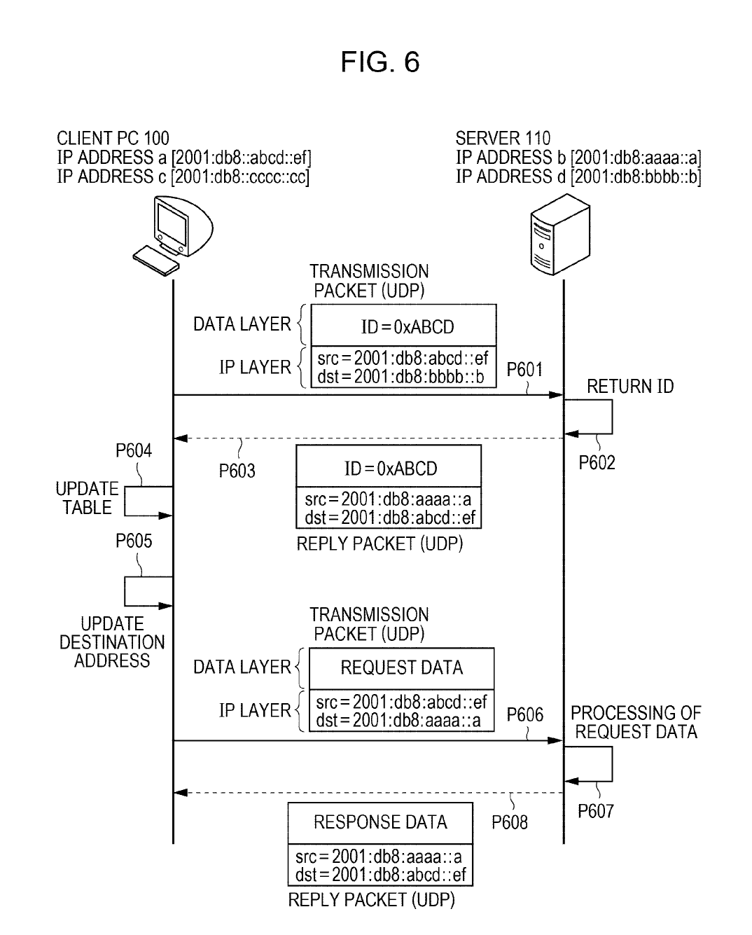

The IP address b allocated to the server 110 is used as the source address 506 of the reply packet. Since multiple IP addresses are practically allocated to the server 110, an IP address selected by the server 110 according to the RFC3484 is used as the source address of the reply packet, as described below in P602 and P607 in FIG. 6.

The response data 505 included in the reply packet 508 corresponds to the transport layer in the OSI reference model.

FIG. 6 is a sequence diagram describing the packet communication between the client PC 100 and the server 110 in detail in the first embodiment. As shown in FIG. 6, an IP address c (2001:db8:cccc::c) is allocated to the client PC 100, in addition to the IP address a (2001:db8:abcd::ef). An IP address d (2001:db8:bbbb::b) is allocated to the server 110, in addition to the IP address b (2001:db8:aaaa:a).

A case in which the application 406 in the client PC 100 is to transmit request data to the application 401 in the server 110 will now be described. In this case, a transmission packet including the request data is transmitted by using the IP address b or d allocated to the server 110 as the destination in related art. However, there are cases in which the source address of the reply packet from the server 110 in response to the transmission packet is different from the destination address of the transmission packet (the reason for this is described below). In such a case, since the client PC does not process any packet whose source address is an IP address different from the one used as the destination address of the transmission packet and discards the packet, the client PC cannot receive the reply packet from the server 110.

In addition, instead of the association between the transmission packet and the reply packet on the basis of the source address of the reply packet, the method of adding IDs to the data corresponding to layers upper than the transport layer and associating the transmission packet with the reply packet by referring to the IDs in the related art is known.

However, when this method is adopted, it is necessary to greatly change the content of the applications of both the client PC 100 and the server 110 so as to add the IDs to the data parts of all the packets to be transmitted to the server 110. It takes a lot of trouble and the cost is increased in this case.

In order to resolve the above problem, the client PC 100 in the first embodiment transmits the transmission packet including certain identification information (ID) to the server 110 only once as pre-preparation for transmission of request data. Then, if the above ID is added to a packet that is received, the client PC 100 extracts the source address of the received packet. In the subsequent transmission of a packet to the server 110, the client PC 100 transmits the packet by using the extracted source address as the destination.

The flow described above will now be described with reference to the sequence diagram shown in FIG. 6. In P601, the client PC 100 transmits a transmission packet as pre-preparation for transmission of request data. An ID 0×ABCD is added to the transmission packet. An IP address arbitrarily selected by the client PC 100 from the IP addresses b and d allocated to the server 110 is used as the destination address of the transmission packet.

The arbitrary selection means, for example, selection of an IP address for which the highest priority is set from the multiple IP addresses acquired by name resolution using Domain Name System (DNS). In the example shown in FIG. 6, the IP address d is selected and is used as the destination address.

In addition, an IP address selected from the IP addresses a and c allocated to the client PC 100 by a method according to the RFC3484 is used as the source address of the transmission packet transmitted in P601. In other words, an IP address having a longer prefix for the IP address d selected as the destination address is selected from the IP addresses a and c. In the example shown in FIG. 6, the IP address a is selected and is used as the source address.

In P602, the server 110 creates a reply packet. The ID included in the transmission packet is added to the reply packet. In P603, the server 110 transmits the reply packet to the client PC 100.

The IP address a used as the source address of the transmission packet in P601 is used as the destination address of the reply packet. In addition, an IP address selected from the IP addresses b and d allocated to the server 110 by a method according to the RFC3484 is used as the source address of the reply packet transmitted in P603. In other words, an IP address having a longer prefix for the IP address a selected as the destination address is selected from the IP addresses b and d. In the example shown in FIG. 6, the IP address b is selected and is used as the source address.

According to the above flow, the source address (the IP address b) of the reply packet transmitted from the server 110 is different from the destination address (the IP address d) of the transmission packet first transmitted from the client PC 100.

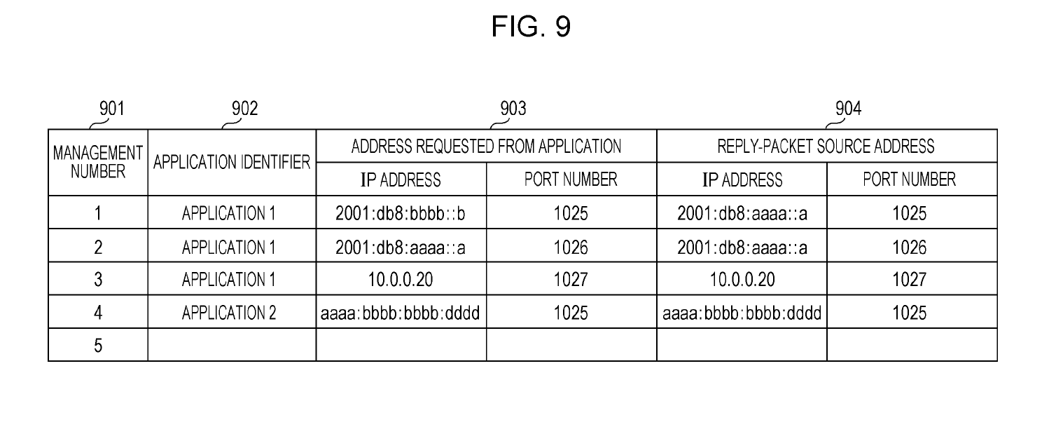

In P604, the client PC 100, which receives the packet from the server 110, refers to the ID (0×ABCD) in the reply packet to determine that the received packet is the reply packet to the transmission packet transmitted in P601. The client PC 100 extracts the source address of the received reply packet and updates a table shown in FIG. 9 described below.

In P605, the client PC 100 updates the IP address used in the subsequent transmission of a packet to the server 110 from the IP address d used in the transmission in P601 to the IP address b extracted in P604. If the destination address of the transmission packet transmitted from the client PC 100 in P601 coincides with the source address of the reply packet transmitted from the server 110 in P603, the processing in P605 is not required.

In P606, the client PC 100 transmits a transmission packet including request data to the server 110. The ID added to the transmission packet in P601 is not added to the request data. The IP address b updated in P605 is used as the destination address of the transmission packet transmitted in P606 and the IP address a is used as the source address.

In P607, the server 110 processes the request data to generate response data to the request data. The ID added to the reply packet in P603 is not added to the response data.

In P608, the server 110 transmits a reply packet including the response data to the client PC 100. The IP address a used as the source address of the transmission packet in P606 is used as the destination address of the reply packet. In addition, an IP address selected from the IP addresses b and d allocated to the server 110 by a method according to the RFC3484 is used as the source address of the reply packet transmitted in P608. In other words, an IP address having a longer prefix for the IP address a selected as the destination address is selected from the IP addresses b and d. As a result, the IP address b, which is the same as the one used as the source address of the reply packet in P603, is selected.

Since the client PC 100 receives the packet whose source address is the IP address coinciding with the destination address of the transmission packet transmitted in P606, the client PC 100 can determine that the received packet is the reply packet to the transmission packet transmitted in P606.

As described above, the client PC 100 transmits the transmission packet to which certain identification information (ID) is added to the server 110 only once as pre-preparation for transmission of request data. Then, the client PC 100 extracts the source address of the reply packet to the transmission packet and uses the extracted address as the subsequent destination address. Accordingly, it is possible to associate the request data with the response data (associate the transmission packet with the reply packet) without adding the ID to the request data to be subsequently transmitted to the server 110.

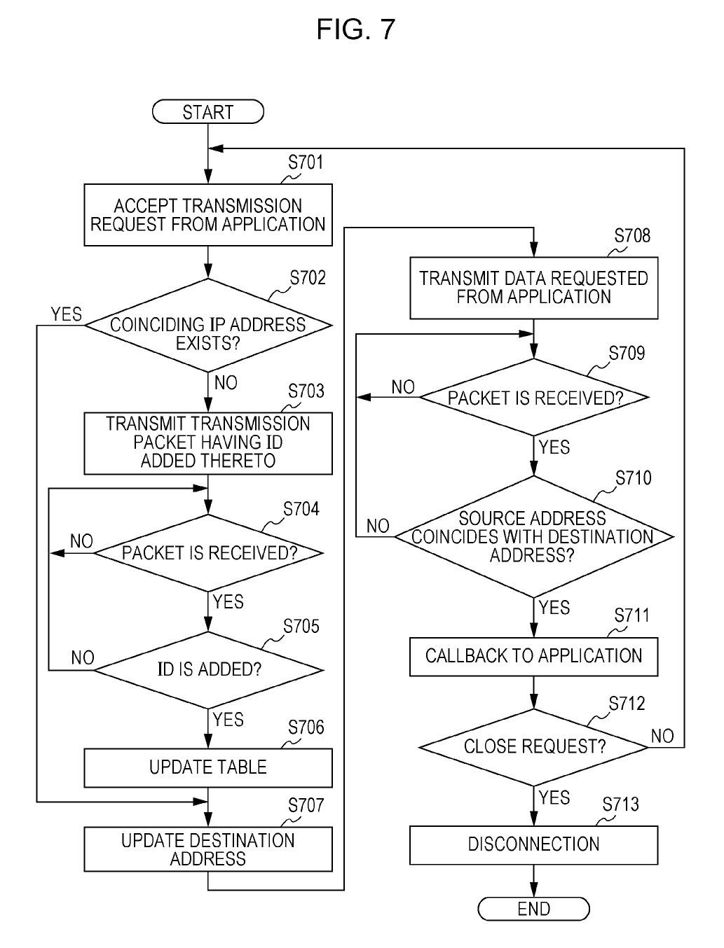

FIG. 7 is a flowchart describing a process performed by the communication controller 405 in the client PC 100 in transmission of a packet from the client PC 100 to the server 110. Each step in the flowchart in FIG. 7 is executed by the CPU 211 in the client PC 100 that executes the control program.

In Step S701, the communication controller 405 accepts a transmission request from the application 406. In Step S702, the communication controller 405 refers to an address management table described below with reference to FIG. 9 to determine whether the IP address coinciding with the destination address specified by the application 406 is included in a requested address 903 in the table. The process goes to Step S707 if the communication controller 405 determines that the coinciding IP address exists and the process otherwise goes to Step S703.

In Step S703, the communication controller 405 transmits a transmission packet to which certain identification information (ID) is added to the destination address specified by the application 406 (P601 in FIG. 6). In this step, the destination address specified by the application 406 is added to the requested address 903 in the address management table shown in FIG. 9 as a new record.

In Step S704, the communication controller 405 determines whether a packet for the client PC 100 is received. If a packet for the client PC 100 is received, in Step S705, the communication controller 405 determines whether the same ID as the one added to the transmission packet transmitted in Step S703 is added to the received packet. The process goes to Step S706 if the communication controller 405 determines that the ID is added. When the ID is added to the received packet, it can be determined that the packet is the reply packet to the transmission packet transmitted in Step S703.

In Step S706, the communication controller 405 extracts the source address of the received reply packet and adds the extracted source address to a source address 904 in the address management table shown in FIG. 9 (P604 in FIG. 6). In Step S707, if the destination address specified by the application 406 is different from the source address extracted in Step S706, the communication controller 405 updates the destination address to be used to the IP address extracted in S706 (P605 in FIG. 6). If the destination address specified by the application 406 coincides with the source address extracted in Step S706, the processing here is not required.

In Step S708, the communication controller 405 transmits the data the transmission of which is requested from the application to the server 110 by using the source address extracted in Step S706 as the destination address

(P606 in FIG. 6).

In Step S709, the communication controller 405 determines whether a packet for the client PC 100 is received. If a packet for the client PC 100 is received, in Step S710, the communication controller 405 determines whether the source address of the received packet coincides with the destination address of the transmission packet transmitted in Step S708. If the communication controller 405 determines that the source address of the received packet coincides with the destination address of the transmission packet transmitted in Step S708, the process goes to Step S711. When the source address of the received packet coincides with the destination address of the transmission packet transmitted in Step S708, it can be determined that the received packet is the reply packet to the transmission packet transmitted in Step S708.

In Step S711, the communication controller 405 calls back the result of the communication with the server 110 to the application 406 (notifies the application 406 of the result of the communication with the server 110). It is possible to set in advance the IP address originally specified by the application 406, the IP address updated in Step S707, or both of the above addresses as the IP address of the server 110 to be notified to the application 406.

In Step S712, the communication controller 405 determines whether a close request from the application 406 is received. If a close request is received, in Step S713, the communication controller 405 disconnects the communication and the process is terminated. If no close request is received from the application 406, the process goes back to Step S701 to continue the process.

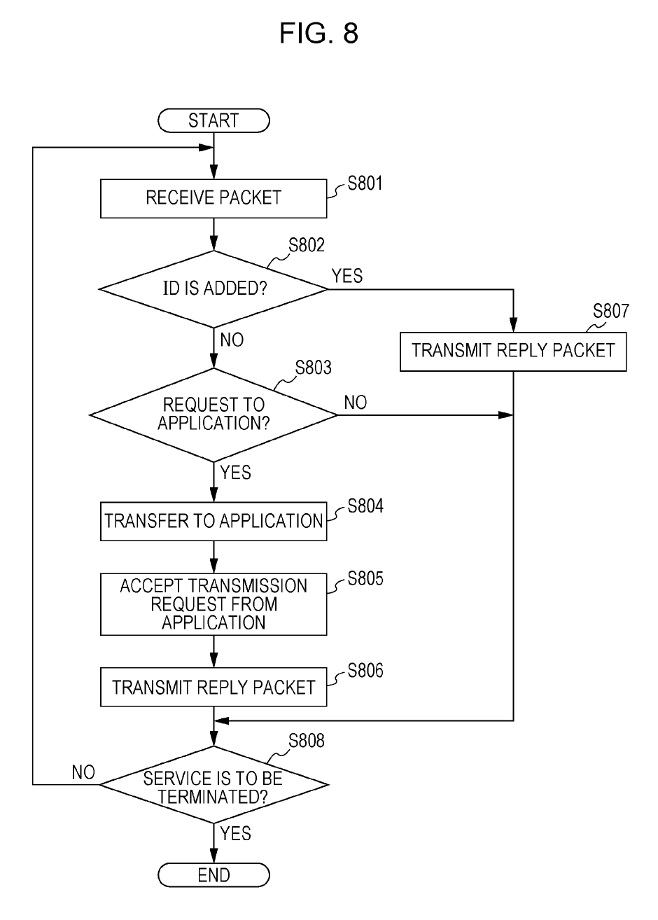

FIG. 8 is a flowchart describing a process performed by the communication controller 402 in the server 110 in transmission of a packet from the client PC 100 to the server 110. Each step in the flowchart in FIG. 8 is executed by the CPU 311 in the server 110 that executes the control program.

In Step S801, the communication controller 402 receives a packet for the server 110. In Step S802, the communication controller 402 determines whether certain identification information (ID) is added to the received packet. The process goes to Step S807 if the communication controller 402 determines that an ID is added and the process otherwise goes to Step S803.

In Step S807, the communication controller 402 creates a reply packet and transmits the created reply packet without transferring the data in the received packet to the application 401 (P603 in FIG. 6). The source address of the packet received in Step S801 is used as the destination address of the reply packet. The IP address selected by a method according to the RFC3484 is used as the source address of the reply packet, as described in P602 in FIG. 6.

In Step S803, the communication controller 402 determines whether the received packet is a processing request to the application 401. If the communication controller 402 determines that the received packet is a processing request to the application 401, the process goes to Step S804. If the received packet is not a processing request to the application 401, the communication controller 402 discards the received packet and the process goes to Step S808.

In Step S804, the communication controller 402 transfers the data included in the received packet to the application 401. In Step S805, the communication controller 402 accepts a transmission request from the application 401.

In Step S806, the communication controller 402 transmits the data (response data) the transmission of which is requested from the application 401 as a reply packet (P608 in FIG. 6). The source address of the packet received in Step S801 is used as the destination address of the reply packet. The IP address selected by a method according to the RFC3484 is used as the source address of the reply packet, as described in P607 in FIG. 6.

In Step S808, the communication controller 402 determines whether the service provided by the application 401 is to be terminated. If the service provided by the application 401 is to be terminated, the process is terminated. If the service provided by the application 401 is not to be terminated, the process goes back to Step S801 to continue the process.

FIG. 9 is a diagram showing an address management table stored in the HDD 214. A management number 901, an application identifier 902, an address 903 requested from application, and a reply-packet source address 904 are managed in the address management table in association with each other.

The management number 901 is information for uniquely identifying each record managed in the address management table. The application identifier 902 is information for identifying the application from which the transmission request is submitted in Step S701 in FIG. 7.

The address 903 requested from application is information added to the address management table in Step S703. The reply-packet source address 904 is information added to the address management table in Step S706.

As described above, in the first embodiment, a transmission packet to which the ID is added is transmitted only once as pre-preparation for transmission of request data, and the source address of the reply packet to this transmission packet is extracted. The extracted source address is used as the destination address in the subsequent transmission of a packet (in the subsequent transmission of request data). Accordingly, it is possible to associate the request with the response (associate the transmission packet with the reply packet) without adding the ID to the data processed by the application in the UDP communication. In other words, it is possible to establish the UDP communication between the client PC 100 and the server 110 without greatly changing the content of the programs of the applications if no resource for establishing many Transmission Control Protocol (TCP) sessions exists at the side of the server 110.

### Second Embodiment

A second embodiment of the present invention will now be described. A transmission packet to which the ID is added is transmitted only once as pre-preparation for transmission of request data and the source address of the reply packet to this transmission packet is extracted in the first embodiment.

However, when a communication device, such as a router, or software, such as a firewall, exists between the client PC 100 and the server 110, “Ingress Filtering Problem” can occur. The “Ingress Filtering Problem” is a problem in that, if the destination address of a transmission packet is different from the source address of the corresponding reply packet, the router or the firewall does not let the reply packet through and discards the reply packet.

Accordingly, if the source address of the reply packet transmitted from the server 110 is different from the destination address of the transmission packet that has been transmitted from the client PC 100, the client PC 100 cannot receive the packet. Consequently, this problem cannot be addressed by the method described in the first embodiment.

In the second embodiment, a TCP packet is used in which the source address of the reply packet transmitted from the server 110 is not differentiated from the destination address of the transmission packet that has been transmitted from the client PC 100.

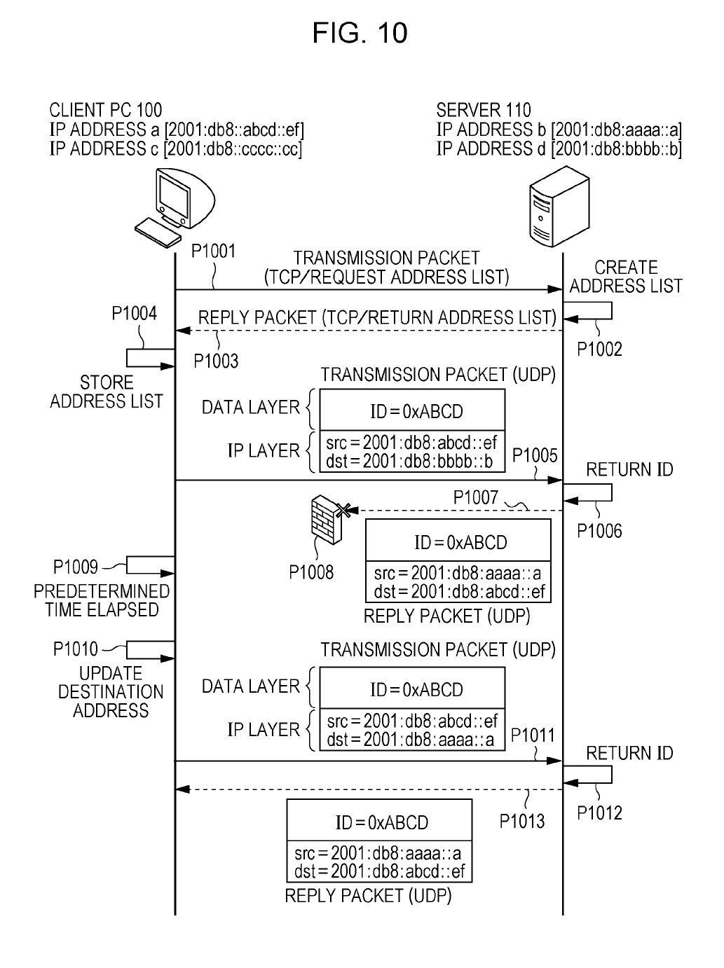

FIG. 10 is a sequence diagram describing the packet communication between the client PC 100 and the server 110 in detail in the second embodiment. As in the diagram in FIG. 6, the IP address c (2001:db8:cccc::c) is allocated to the client PC 100, in addition to the IP address a (2001:db8:abcd::ef). The IP address d (2001:db8:bbbb::b) is allocated to the server 110, in addition to the IP address b (2001:db8:aaaa:a).

In P1001, the client PC 100 in the second embodiment requests an address list from the server 110 by using a TCP packet as pre-preparation for transmission of request data. Upon reception of this request, in P1002, the server 110 creates an address list in which multiple IP addresses allocated to the server 110 are described. In P1003, the server 110 transmits the address list to the client PC 100 by using a TCP packet.

Since the destination address of the transmission packet is used as the source address of the corresponding reply packet in the communication using TCP packets, the source address of the reply packet is not differentiated from the destination address of the transmission packet.

In P1004, the client PC 100 stores the received address list in the HDD 214.

In P1005, the client PC 100 transmits a transmission packet to which certain identification information (ID) is added to the server 110, as in the processing in P601 in FIG. 6. The transmission packet is an UDP packet.

In P1006, the server 110 creates a reply packet, as in the processing in P602 in FIG. 6. The ID included in the transmission packet is added to this reply packet. In Step P1007, the server 110 transmits the reply packet to the client PC 100, as in P603 in FIG. 6.

In P1008, the reply packet from the server 110 is discarded by a router or a firewall existing between the client PC 100 and the server 110. This is because the destination address (the IP address d) of the transmission packet in P1005 is different from the source address (the IP address b) of the reply packet in P1007 and, thus, it is determined that a Denial of Service (DoS) attack can occur.

In P1009, the client PC 100 detects that a predetermined time elapsed without receiving a reply packet from the server 110 since the client PC 100 has transmitted the transmission packet in P1005. In P1010, the client PC 100 refers to the address list stored in P1004 to acquire an IP address other than the destination address used in the transmission packet in P1005 and updates the destination address to the acquired IP address.

In P1011, the client PC 100 transmits a transmission packet to which the ID is added to the server 110 again by using the IP address after the update as the destination. In P1012, the server 110 creates a reply packet. The ID included in the transmission packet is added to the reply packet. In P1013, the server 110 transmits the reply packet to the client PC 100, as in P1007 in FIG. 10.

The reply packet transmitted in P1013 passes through the router or the firewall and reaches the client PC 100, unlike the reply packet transmitted in P1007. This is because the destination address (the IP address b) of the transmission packet in P1011 coincides with the source address (the IP address b) of the reply packet in P1013.

According to the above flow, the client PC 100 can know the IP address (the IP address b) appropriate for transmission of an UDP packet to the server 110. Accordingly, the client PC 100 can use the IP address b as the destination address to normally communicate with the server 110 in the subsequent transmission of request data to the server 110.

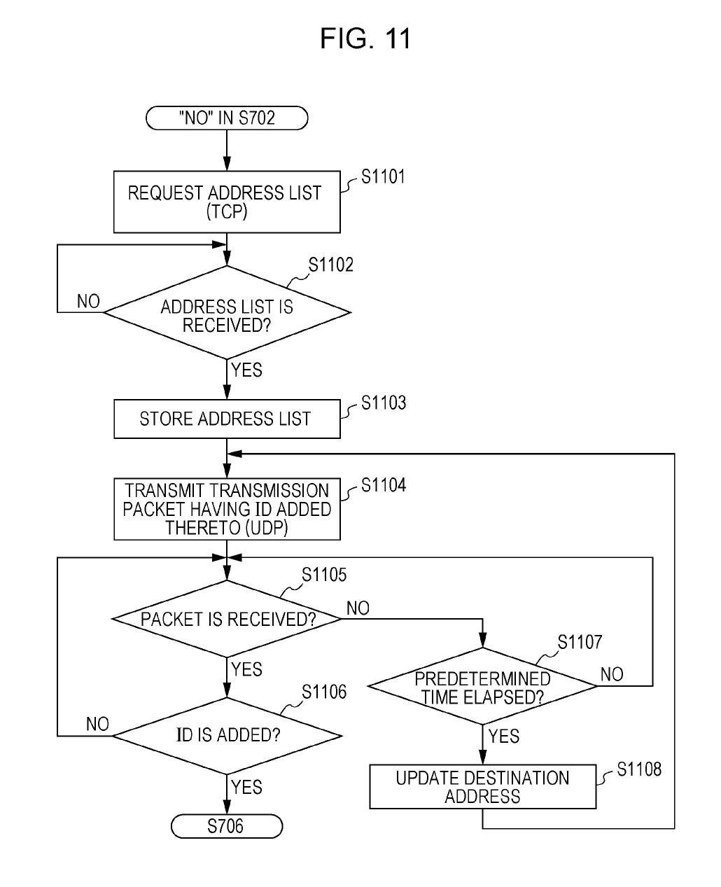

FIG. 11 is a flowchart describing a process performed by the communication controller 405 in the client PC 100 in transmission of a packet from the client PC 100 to the server 110. Each step in the flowchart in FIG. 11 is executed by the CPU 211 in the client PC 100 that executes the control program.

The flowchart shown in FIG. 11 is started when the determination in Step S702 in FIG. 7 is “negative.” In Step S1101, the communication controller 405 requests an address list from the server 110 by using a TCP packet (P1001 in FIG. 10).

In Step S1102, the communication controller 405 determines whether an address list is received from the server 110. If an address list is received, the process goes to Step S1103. In Step S1103, the communication controller 405 stores the received address list in the HDD 214 (P1004 in FIG. 10).

In Step S1104, the communication controller 405 transmits a transmission packet to which certain identification information (ID) is added to the destination address specified by the application 406 (P1005 in FIG. 10). The destination address specified by the application 406 is added to the requested address 903 in the address management table shown in FIG. 9 as a new record.

In Step S1105, the communication controller 405 determines whether a packet for the client PC 100 is received. If a packet for the client PC 100 is received, in Step S1106, the communication controller 405 determines whether the ID added to the transmission packet transmitted in Step S1104 is added to the received packet. If the communication controller 405 determines that the ID is added, the process goes to Step S706 in FIG. 7. When the ID is added to the received packet, it can be determined that the packet is the reply packet to the transmission packet transmitted in Step S1104.

If the communication controller 405 determines in Step S1105 that a packet for the client PC 100 is not received, in Step S1107, the communication controller 405 determines whether a predetermined time elapsed since the transmission packet has been transmitted in Step S1104.

The process goes to Step S1108 if the communication controller 405 determines that the predetermined time elapsed and the process otherwise goes back to Step S1105. In Step S1108, the communication controller 405 updates the destination address to an IP address different from the one used in the transmission packet in Step S1104, among the IP addresses included in the address list stored in Step S1103.

If there is no IP address that is not used (all the IP addresses included in the address list have been used), a communication error is transmitted to the application 406. After updating the destination address in Step S1108, the process goes back to Step S1104 and the communication controller 405 transmits a transmission packet to which the ID is added to the destination address after the update.

As described above, in the second embodiment, the address list of the server 110 is acquired by using a TCP packet as pre-preparation for transmission of request data. Then, if the reply packet cannot be received from the server 110 due to the existence of the router or the firewall, a transmission packet to which the ID is added is transmitted again by using another IP address included in the address list as the destination. With this method, it is possible to establish the normal communication with the server 110 even in the environment in which the router or the firewall exists.

### Other Embodiments

The object of the present invention is also achieved by performing the following processing. Specifically, a recording medium in which program code of software realizing the functions of the above embodiments is stored is supplied to a system or an apparatus, the computer (or the CPU or a micro processor unit (MPU)) in the system or the apparatus reads out the program code stored in the recording medium.

In this case, the program code itself read out from the recording medium realizes the functions of the embodiments described above, and the present invention is embodied by the program code and the recording medium storing the program code.

The present invention is not limited to the above embodiments, and various changes and variations may be made without departing from the spirit or scope of the present invention. Accordingly, the following claims are appended in order to make the range of the present invention clear.

According to the present invention, it is possible to communicate with an external apparatus to which multiple addresses are allocated without a lot of trouble and an increase in cost.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of International Patent Application No. PCT/JP2010/054917, filed Mar. 23, 2010, which is hereby incorporated by reference herein in its entirety.

What is claimed is:

1. An apparatus that can be connected to an external apparatus to which a plurality of addresses are allocated over a network, the apparatus comprising:
a transmitting unit configured to transmit a first packet including certain identification information to the external apparatus using a first address in the plurality of addresses as a destination;
a receiving unit configured to receive a second packet transmitted from the external apparatus;
an extracting unit configured to, if the certain identification information is included in the second packet, extract a source address of the second packet; and
a control unit configured to, if the extracted source address is a second address, control a subsequent transmission of a third packet to the external apparatus so as to use the second address as the destination.

2. The apparatus according to claim 1,
wherein the certain identification information is not included in the third packet.

3. The apparatus according to claim 1, further comprising:
a managing unit configured to manage the destination address used in the transmission of the first packet and the extracted source address in association with each other; and
a determining unit configured to, if transmission of a new packet whose destination is a certain address is requested, determine whether the certain address coincides with the destination address,
wherein the control unit controls transmission of the new packet so as to use the source address in association with the certain address as the destination if the certain address coincides with the destination address.

4. The apparatus according to claim 3,
wherein the transmitting unit transmits the first packet using the certain address as the destination if the certain address does not coincide with the destination address.

5. The apparatus according to claim 1, further comprising:
a requesting unit configured to request an address list indicating the plurality of addresses by transmitting a Transmission Control Protocol packet; and
a storage unit configured to store the transmitted address list in response to the request from the requesting unit,
wherein the transmitting unit refers to the stored address list to transmit the first packet to an address included in the address list.

6. The apparatus according to claim 1,
wherein the first packet is a User Datagram Protocol packet.

7. A method of controlling an apparatus that can be connected to an external apparatus to which a plurality of addresses are allocated over a network, the method comprising:
transmitting a first packet including certain identification information to the external apparatus using a first address in the plurality of addresses as a destination;
receiving a second packet transmitted from the external apparatus;
extracting, if the certain identification information is included in the second packet, a source address of the second packet; and
controlling, if the extracted source address is a second address, a subsequent transmission of a third packet to the external apparatus so as to use the second address as the destination.

8. The method according to claim 7,
wherein the certain identification information is not included in the third packet.

9. The method according to claim 7, further comprising:
managing the destination address used in the transmission of the first packet and the extracted source address in association with each other;
determining whether the certain address coincides with the destination address, if transmission of a new packet whose destination is a certain address is requested; and
controlling transmission of the new packet so as to use the source address in association with the certain address as the destination if the certain address coincides with the destination address.

10. The method according to claim 9, further comprising
transmitting the first packet using the certain address as the destination if the certain address does not coincide with the destination address.

11. The method according to claim 7, further comprising:
requesting an address list indicating the plurality of addresses by transmitting a Transmission Control Protocol packet;
storing the transmitted address list in response to the request from the requesting unit; and
referring to the stored address list to transmit the first packet to an address included in the address list.

12. The method according to claim 7,
wherein the first packet is a User Datagram Protocol packet.

13. A computer readable storage medium storing a computer-executable program of instructions for causing a computer to perform the method of controlling an apparatus according to claim 7.

14. The computer readable storage medium according to claim 13,
wherein the certain identification information is not included in the third packet.

15. The computer readable storage medium according to claim 13, further comprising:
managing the destination address used in the transmission of the first packet and the extracted source address in association with each other;
determining whether the certain address coincides with the destination address, if transmission of a new packet whose destination is a certain address is requested; and
controlling transmission of the new packet so as to use the source address in association with the certain address as the destination if the certain address coincides with the destination address.

16. The computer readable storage medium according to claim 15, further comprising
transmitting the first packet using the certain address as the destination if the certain address does not coincide with the destination address.

17. The computer readable storage medium according to claim 13, further comprising:
requesting an address list indicating the plurality of addresses by transmitting a Transmission Control Protocol packet;
storing the transmitted address list in response to the request from the requesting unit; and
referring to the stored address list to transmit the first packet to an address included in the address list.

18. The computer readable storage medium according to claim 13,
wherein the first packet is a User Datagram Protocol packet.
